(19) United States
(12) Patent Application Publication
(10) Pub. No.: US 2023/0016002 A1
(43) Pub. Date: Jan. 19, 2023

(54) DRUM HARDWARE TOOLS

(71) Applicant: Drumzi, Inc., Birmingham, MI (US)

(72) Inventors: Rod Morgenstein, Birmingham, MI (US); Jim Mooradian, Birmingham, MI (US); Joseph Naylor, Birmingham, MI (US)

(73) Assignee: Drumzi, Inc., Birmingham, MI (US)

(21) Appl. No.: 17/588,071

(22) Filed: Jan. 28, 2022

Related U.S. Application Data
(60) Provisional application No. 63/142,728, filed on Jan. 28, 2021.

(51) Int. Cl. B25B 13/50; G10D 13/10

(52) U.S. Cl. CPC B25B 13/5091; G10D 13/10

(57) ABSTRACT

Drum hardware tools are described. Some implementations may include a tension rod hardware tool designed for assembling/installing/setting up and/or disassembling/uninstalling tension rods. Some implementations may include a drum wing nut hardware tool designed for assembling/installing/setting up and/or disassembling/uninstalling drum hardware wing nuts.

### RELATED APPLICATIONS

This application claims the benefit of U.S. Provisional Application No. 63/142,728, filed on Jan. 28, 2021, and entitled “Drum Hardware Tool,” which is incorporated herein by reference in its entirety.

### FIELD OF INVENTION

Some implementations relate generally to hardware tools, and more specifically to drum hardware tools that can enable or assist with the assembly and/or the disassembly of drum kits.

### BACKGROUND

Drum kit hardware usually comprises different types of fasteners. One commonly used fastener, typically used to secure a drumhead to a shell of a drum, is a fastener that has a square shaped head having a size of about 5.7 mm, colloquially referred to as a “tension rod”. Lengths of tension rods are not uniform and may vary in size depending on the requirements. However, the square shaped drumheads are generally 5.7 mm in size. A specialty tool, colloquially referred to as a “drum key”, is commonly used for tightening and/or tuning drumheads. Drum keys are typically “T” shaped and include a drive socket end configured to fit over the tension rod's square shaped head. This end is typically located at or near the bottom of the “T” shape.

Another fastener commonly used with drum kit hardware is a wing nut type fastener that can be tightened or loosened by hand. These wing nut type fasteners are generally installed on drum kit stands and are designed such that a tool is not required to either loosen or tighten the wing nut type fasteners when adjusting the drum kit stands. These fasteners enable a user to make an adjustment to the drum kit hardware by hand, especially if the hardware is new or has not been strongly/tightly torqued down. However, if the hardware is not new or has been torqued down strongly/tightly, the wing nut type fasteners can be difficult to loosen or tighten by hand. For example, wing nut type fasteners can get jammed from using too much torque or due to corrosion, rendering them difficult to tightening or loosening manually with a user's bare hands.

Embodiments were conceived in light of the above-mentioned problems and limitations, among other things. The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

### SUMMARY

Some implementations include a tension rod tool comprising a socket end, a socket shaft, a socket handle, and a socket handle side symbol. In some implementations, the socket end may be shaped in a form of one of a square, a rectangle, a pentagon, a hexagon, a heptagon, an octagon, a circle, or an oval. In some implementations, the socket end may be shaped in a form of a polygon, wherein each side of the polygon may have a dimension of 5.7 millimeter. In some implementations, the socket handle side symbol may provide one or more of a visual indication or a view of the handle end of the tension rod tool. In some implementations, the socket shaft may be made of one or more of wood, plastic, metal, stone, a natural material, a synthetic material, or a composite material. In some implementations, the socket handle may be made of one of plastic, metal, stone, wood, a natural material, a synthetic material, or a composite material. In some implementations, the socket end may be made of one or more of wood, plastic, metal, stone, a natural material, a synthetic material, or a composite material, or similar material.

Some implementations include a wing nut tool comprising a first end, a middle section, a second end, a first wing nut aperture, a second wing nut aperture, a first narrow edge, a second narrow edge, and one or more slots. In some implementations, the first wing nut aperture and the second wing nut aperture may have equal dimensions. In some implementations, the first wing nut aperture is of a first dimension and the second wing nut aperture is of a second dimension, wherein the first dimension may be different than/from the second dimension. In some implementations, the wing nut tool may be made of one or more of plastic, metal, stone, wood, a natural material, a synthetic material, or a composite material. In some implementations, the middle section may comprise one or more slots. In some implementations, the one or more slots may be oriented in one or more of a horizontal orientation, a vertical orientation, or an oblique orientation. In some implementations, the one or more slots may form one or more of an oval shape, a square shape, a rectangular shape, a circular shape, or a polygonal shape, for example.

Some implementations can include a hardware tool comprising a drive socket end, a drive socket shaft, a drive socket handle, and a drive socket handle side symbol. In some of the implementations, the drive socket end may be shaped in a form of one of a square, a rectangle, a pentagon, a hexagon, a heptagon, an octagon, a circle, or an oval. In some implementations, the drive socket end may be shaped as a polygon, wherein each side of the polygon has a dimension of 5.7 millimeter. In some implementations, the drive socket handle side symbol may provide one or more of a visual indication or a view of the drive socket handle end of the hardware tool. In some implementations, the drive socket shaft may be made of one or more of wood, plastic, metal, stone, a natural material, a synthetic material, or a composite material. In some implementations, the drive socket handle may be made of one or more of plastic, metal, stone, wood, a natural material, a synthetic material, or a composite material, or other similar material.

### BRIEF DESCRIPTION OF THE DRAWINGS

FIG. 1 is a diagram showing a side view of an example tension rod hardware tool in accordance with some implementations.

FIG. 2 is a diagram showing a first end view of an example tension rod hardware tool in accordance with some implementations.

FIG. 3 is a diagram showing a second end view of an example tension rod hardware tool in accordance with some implementations.

FIG. 4 is a diagram showing a front side view of an example wing nut hardware tool in accordance with some implementations.

FIG. 5 is a diagram showing a back view of an example wing nut hardware tool in accordance with some implementations.

FIG. 6 is a diagram showing a front side view of an example wing nut hardware tool in accordance with some implementations.

FIG. 7 is a diagram showing a detailed view of an example wing nut hardware tool in accordance with some implementations.

FIG. 8 is a diagram showing a detailed view of an example wing nut hardware tool in accordance with some implementations.

FIG. 9 is a diagram showing a side view of an example tension rod hardware tool in use in accordance with some implementations.

FIG. 10 is a diagram showing a side view of an example wing nut hardware tool in use in accordance with some implementations.

FIG. 11 is a diagram showing an example tension rod hardware tool in accordance with some implementations.

FIG. 12 is a diagram showing an example tension rod hardware tool in accordance with some implementations.

FIG. 13 is a diagram showing an example wing nut hardware tool in accordance with some implementations.

FIG. 14 is a diagram showing an example wing nut hardware tool in accordance with some implementations.

### DETAILED DESCRIPTION

Some implementations may include a drum wing nut or a wing nut hardware tool and/or a tension rod hardware tool. Either tool may be designed to assist a user in setting up or assembling or installing a drum kit in some implementations. Either tool may be designed to assist a user in disassembling and/or uninstalling a drum kit in some implementations.

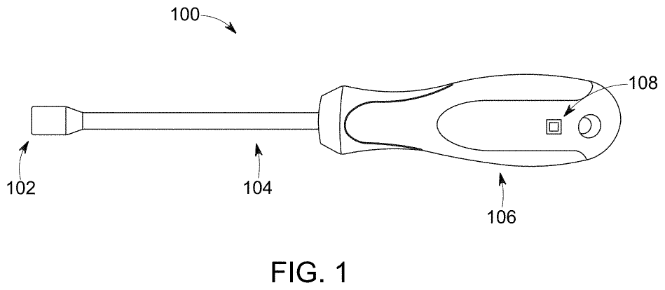

FIG. 1 is a diagram showing a side view of an example tension rod hardware tool in accordance with some implementations. An example tension rod hardware tool 100 includes a drive socket end 102, a drive socket shaft 104, a drive socket handle 106, and a drive socket handle side symbol 108.

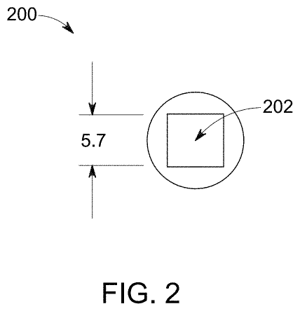

FIG. 2 is a diagram showing a first end view of an example tension rod hardware tool in accordance with some implementations. An example tension rod hardware tool 200 includes a drive socket end 202. FIG. 2 shows a square shaped drive socket end 202 with a side dimension of around 5.7 mm (e.g., within +/−0.1 mm of 5.7 mm) configured to align/fit onto a tension rod.

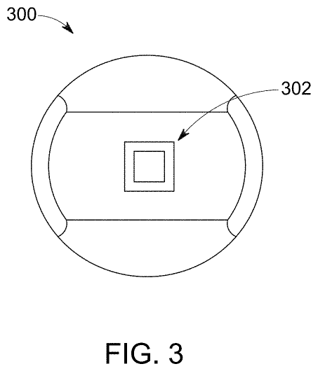

FIG. 3 is a diagram showing a second end view of an example tension rod hardware tool in accordance with some implementations. An example tension rod hardware tool 300 includes a square shaped drive socket handle side symbol 302 (e.g., at opposite end of the drive socket end 202). In some implementations, the square shaped drive socket handle side symbol 302 gives a user a visual indication or a view of the handle end of the tool by making visible the end of the tension rod hardware tool handle that protrudes out of a drummer's tool pouch or stick bag.

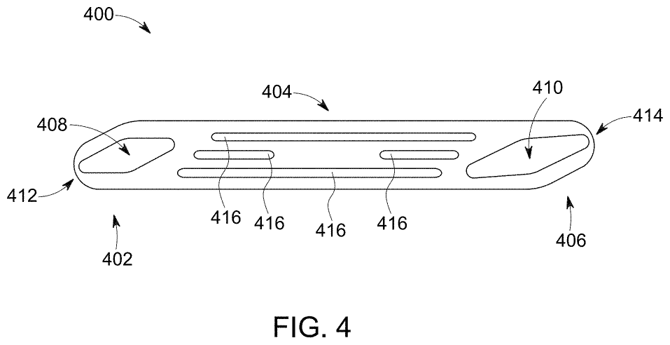

FIG. 4 is a diagram showing a front side view of an example drum wing nut hardware tool in accordance with some implementations. An example drum wing nut hardware tool 400 includes a first end 402, a middle section 404, a second end 406, a first wing nut aperture 408, a second wing nut aperture 410, a first narrow edge 412, a second narrow edge 414, and a plurality of slots 416. The first narrow edge 412 and the second narrow edge 414 enable the drum wing nut hardware tool to access a wing nut fastener located in an area with a tight clearance, i.e., an area that does not offer much space for the tool to maneuver. In some implementations, the drum wing nut hardware tool can be designed to accommodate wing nuts of different sizes and shapes, with a first end 402 including a first wing nut aperture 408 and a second end 406 including a second wing nut aperture 410. In some implementations, the first wing nut aperture 408 may be of a different size, dimension, and/or shape than the second wing nut aperture 410. In some other implementations, the first wing nut aperture 408 may be of the same size, dimension, and/or shape as the second wing nut aperture 410. In some implementations, the middle section 404 (which can be considered to function as a handle) has a plurality of slots 416 that are not only cosmetic but also incorporate dual functionalities. The first function is to form a grip space on the drum wing nut hardware tool and the second function is to help reduce the weight of the drum wing nut hardware tool by removing unnecessary and redundant material from the tool.

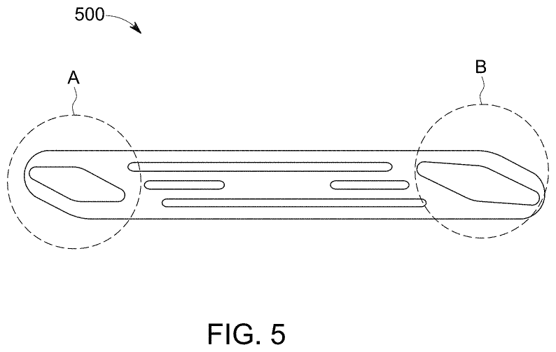

FIG. 5 is a diagram showing a back view of an example drum wing nut hardware tool in accordance with some implementations. Region “A” corresponds to an area including the first wing nut aperture and region “B” corresponds to an area including the second wing nut aperture.

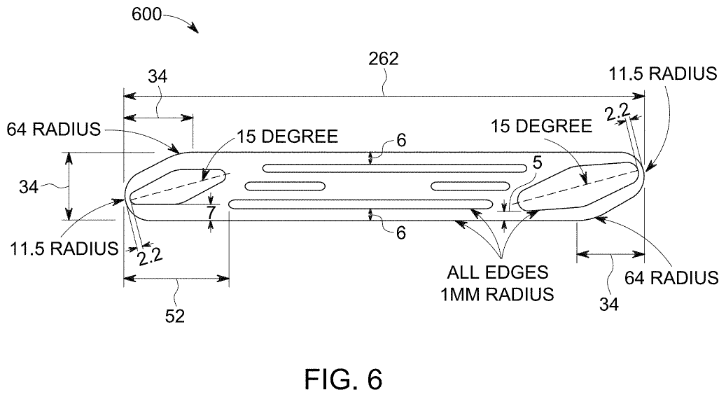

FIG. 6 is a diagram showing a front side view of an example drum wing nut hardware tool in accordance with some implementations. The example drum wing nut hardware tool 600 shows example dimensions, including example dimensions of the radii as well as example degrees of the angles for placement of the first wing nut aperture 408 and the second wing nut aperture 410. The dimensions, the radii, and the degrees of the angles described herein are an example of one embodiment. Other dimensions, radii, and degrees of angles can also be used.

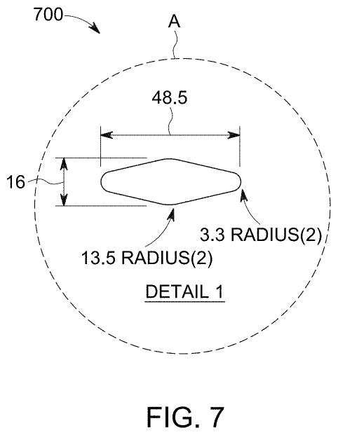

FIG. 7 is a diagram showing a detailed view of an example wing nut aperture of an example drum wing nut hardware tool in accordance with some implementations. The drum wing nut hardware tool 700 shows example dimensions of an example first wing nut aperture.

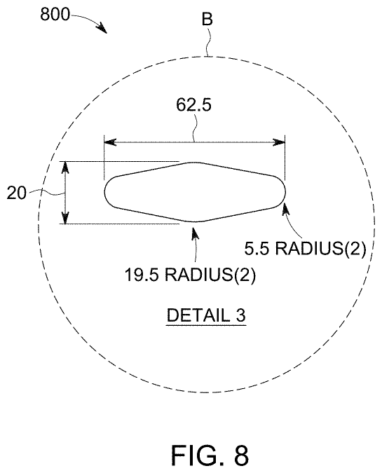

FIG. 8 is a diagram showing a detailed view of an example wing nut aperture of an example drum wing nut hardware tool in accordance with some implementations. The drum wing nut hardware tool 800 shows example dimensions of an example second wing nut aperture.

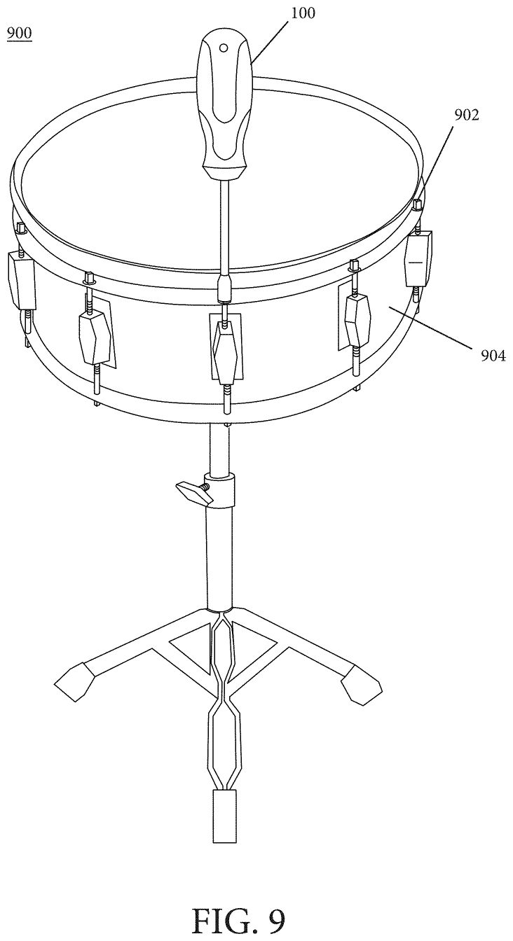

FIG. 9 is a diagram showing a side view of an example tension rod hardware tool in use in accordance with some implementations. FIG. 9 shows a tension rod hardware tool 100 in use with an example drum kit 900 comprising an example tension rod 902 and an example drum 904.

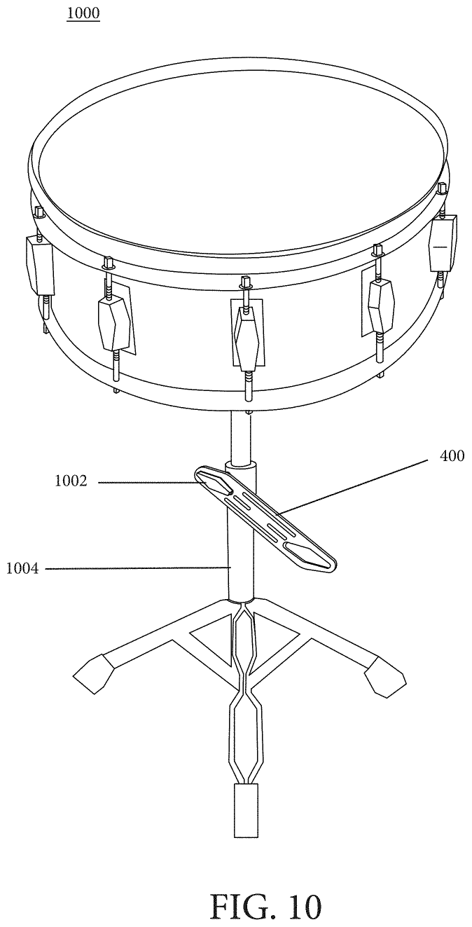

FIG. 10 is a diagram showing a side view of an example drum wing nut hardware tool in use in accordance with some implementations. FIG. 10 shows a drum wing nut hardware tool 400 in use with an example drum kit 1000 comprising an example wing nut 1002 and an example snare drum stand 1004. The wing nuts and snare drum stand shown herein are an example of one embodiment. The tool can be used with other types of wing nuts, snare drums.

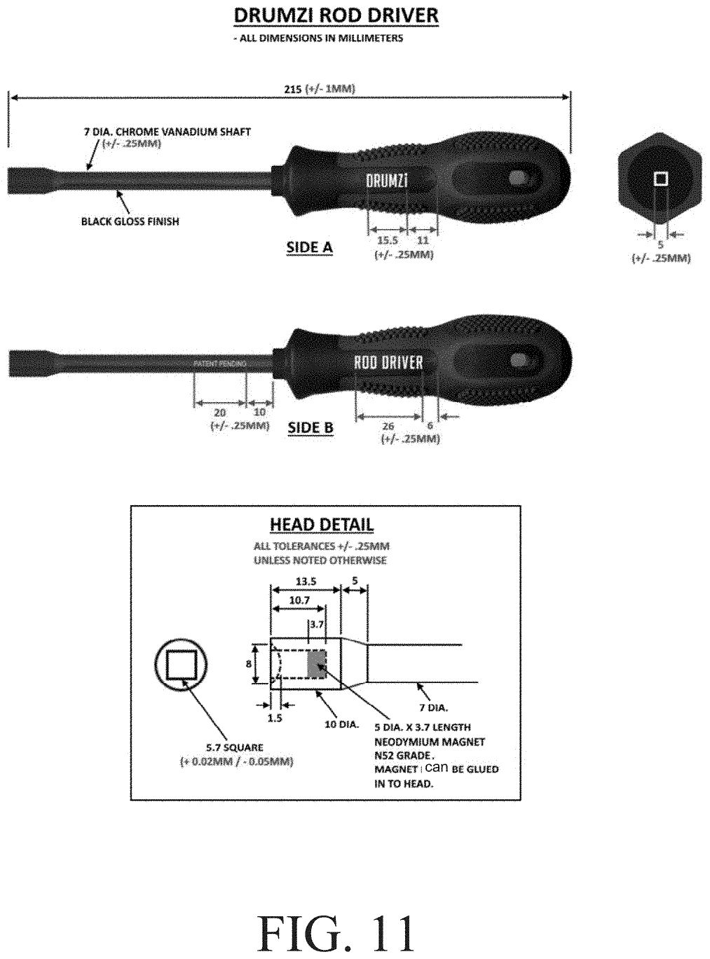

FIG. 11 is a diagram showing an example tension rod hardware tool in accordance with some implementations. In the implementation shown in FIG. 11, the tension rod tool has a different design and a magnet located in the driver end of the tool (e.g., the distal end).

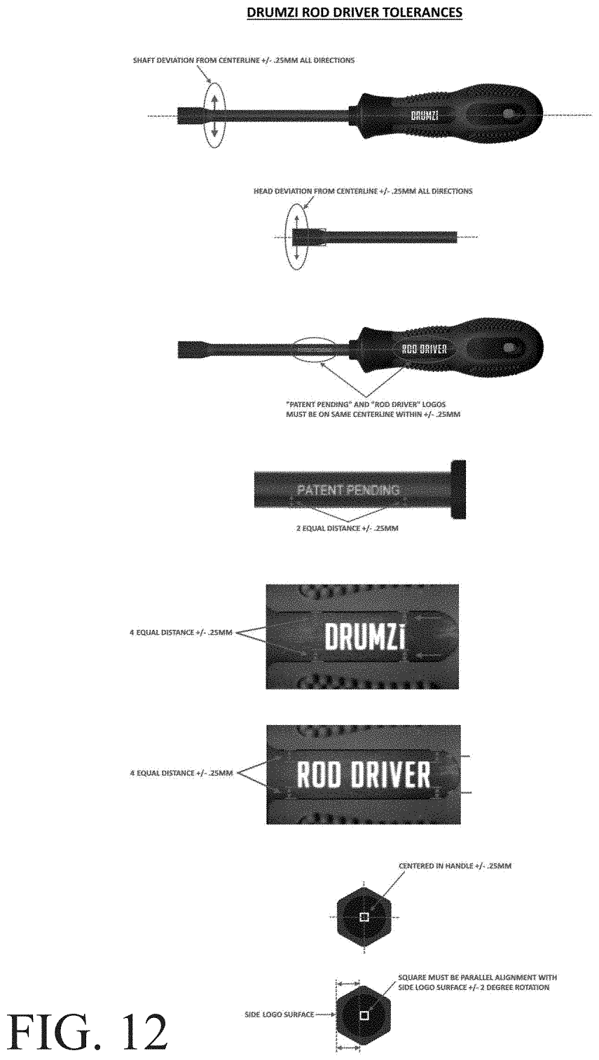

FIG. 12 is a diagram showing an example tension rod hardware tool in accordance with some implementations.

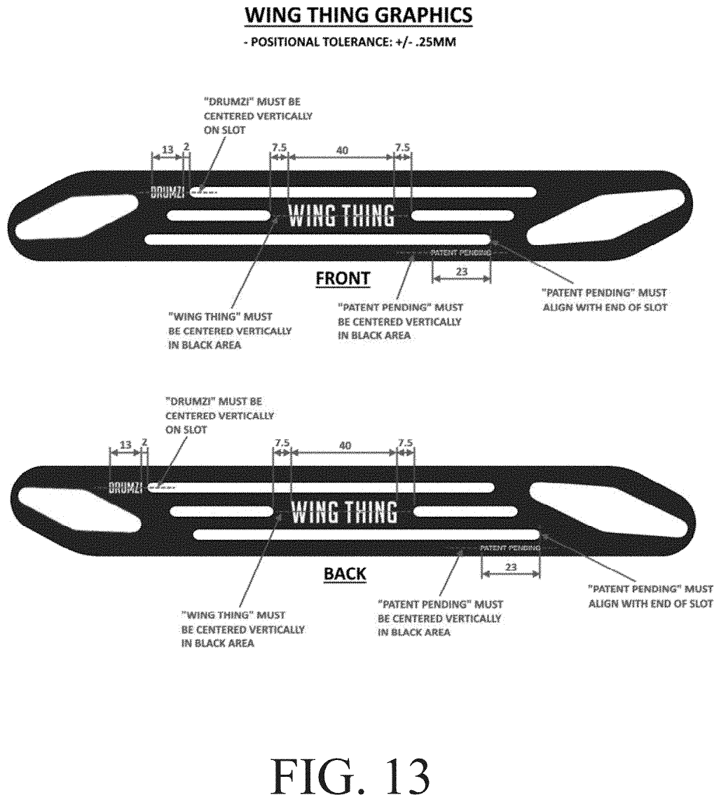

FIG. 13 is a diagram showing an example wing nut hardware tool in accordance with some implementations.

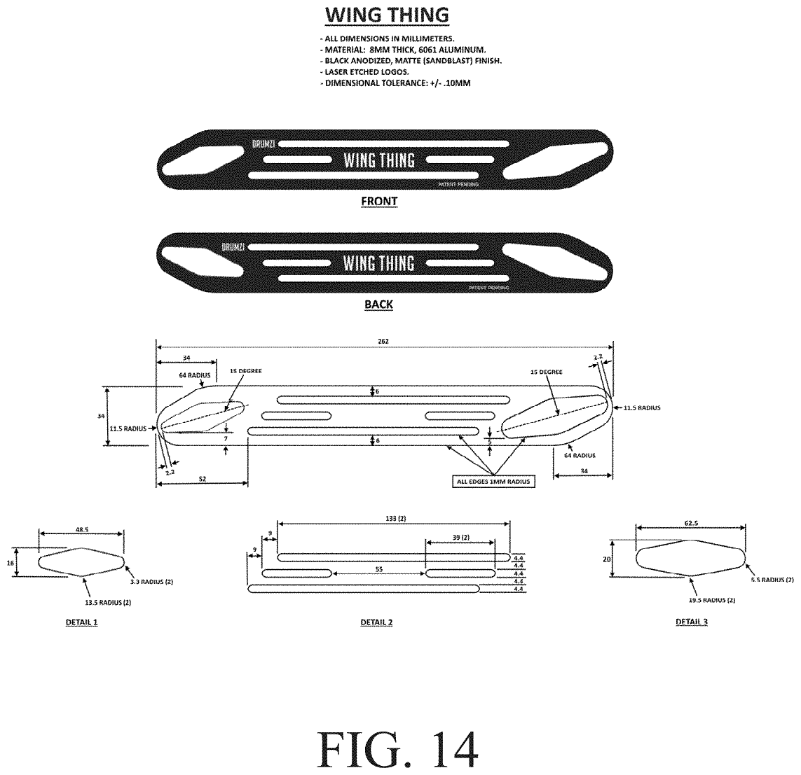

FIG. 14 is a diagram showing an example wing nut hardware tool in accordance with some implementations.

All dimensions are examples that are not intended to be limiting. Other dimensions can be used.

In some implementations of the wing nut or drum wing nut hardware tool, the first wing nut aperture 408 can be of a first dimension and the second wing nut aperture 410 can be of a second dimension, wherein the first dimension is different from/than the second dimension. In some implementations of the wing nut or drum wing nut hardware tool, the first wing nut aperture 408 and the second wing nut aperture 410 may be of the same size or dimension.

The one or more slots of the middle section of the wing nut hardware tool can be oriented in one or more of a horizontal orientation, a vertical orientation, or an oblique orientation. The one or more slots can form one or more of an oval shape, a square shape, a rectangular shape, a circular shape, or a polygonal shape in some implementations of the wing nut hardware tool.

The drive socket end of the tension rod hardware tool can be shaped in the form of a polygon such as a square, a rectangle, a pentagon, a hexagon, a heptagon, or an octagon, or in the form of a circle or an oval. In some implementations, the dimension of each of the polygon's sides or the diameter of the circle can be around 5.7 mm (e.g., within +/−0.1 mm of the 5.7 mm).

The wing nut or drum wing nut hardware tool can be made of one or more of plastic, metal, stone, and/or wood or a natural, a synthetic, or a composite material, among other suitable materials. The tension rod hardware tool (including the socket end, the socket shaft, the socket handle, or the socket handle side symbol) can be made of one or more of a natural, a synthetic, or a composite material, or plastic, metal, stone, and/or wood among other suitable materials.

The wing nut tool or tension rod tool can be made of a composite material, reinforced polymer or plastic material, fiber reinforced composite material, fiber reinforced polymer or plastic material, fiber reinforced resin, unreinforced polymer material, unreinforced plastic material, or other suitable material. The wing nut tool or tension rod tool can be formed via injection molding or other suitable process. The wing nut tool or the tensions rod tool can be formed from a combination of two or more of the materials mentioned above.

While some example implementations have been described in terms of a general embodiment with several specific example modifications, it is recognized that other modifications, implementations, and variations of the embodiments described above are within the spirit and scope of the disclosed subject matter. Applicant intends to embrace any and all such modifications, variations, embodiments, and implementations.

What is claimed is:

1. A tension rod tool comprising:
a socket end;
a socket shaft;
a socket handle; and
a socket handle side symbol.

2. The tension rod tool of claim 1, wherein the socket end is shaped in a form of one of a square, a rectangle, a pentagon, a hexagon, a heptagon, an octagon, a circle, or an oval.

3. The tension rod tool of claim 1, wherein the socket end is shaped in a form of a polygon, and wherein each side of the polygon has a dimension of 5.7 millimeter.

4. The tension rod tool of claim 1, wherein the socket handle side symbol provides one or more of a visual indication or a view of a shape of the socket end of the tension rod tool.

5. The tension rod tool of claim 1, wherein the socket shaft is made of one or more of wood, plastic, metal, stone, a natural material, a synthetic material, or a composite material.

6. The tension rod tool of claim 1, wherein the socket handle is made of one of plastic, metal, stone, wood, a natural material, a synthetic material, or a composite material.

7. The tension rod tool of claim 1, wherein the socket end is made of one or more of wood, plastic, metal, stone, a natural material, a synthetic material, or a composite material.

8. A wing nut tool comprising:
a first end;
a middle section;
a second end;
a first wing nut aperture;
a second wing nut aperture;
a first narrow edge;
a second narrow edge; and
one or more slots.

9. The wing nut tool of claim 8, wherein the first wing nut aperture and the second wing nut aperture have equal dimensions.

10. The wing nut tool of claim 8, wherein the first wing nut aperture is of a first dimension and the second wing nut aperture is of a second dimension, wherein the first dimension is different than the second dimension.

11. The wing nut tool of claim 8, wherein the wing nut tool is made of one or more of plastic, metal, stone, wood, a natural material, a synthetic material, or a composite material.

12. The wing nut tool of claim 8, wherein the middle section comprises one or more slots.

13. The wing nut tool of claim 12, wherein the one or more slots are oriented in one or more of a horizontal orientation, a vertical orientation, or an oblique orientation.

14. The wing nut tool of claim 12, wherein the one or more slots form one or more of an oval shape, a square shape, a rectangular shape, a circular shape, or a polygonal shape.

15. A hardware tool comprising:
a drive socket end;
a drive socket shaft;
a drive socket handle; and
a drive socket handle side symbol.

16. The hardware tool of claim 15, wherein the drive socket end is shaped in a form of one of a square, a rectangle, a pentagon, a hexagon, a heptagon, an octagon, a circle, or an oval.

17. The hardware tool of claim 15, wherein the drive socket end is shaped in a form of a polygon, wherein each side of the polygon has a dimension of 5.7 millimeter.

18. The hardware tool of claim 15, wherein the drive socket handle side symbol provides one or more of a visual indication or a view of the drive socket end of the hardware tool.

19. The hardware tool of claim 15, wherein the drive socket shaft is made of one or more of wood, plastic, metal, stone, a natural material, a synthetic material, or composite material.

20. The hardware tool of claim 15, wherein the drive socket handle is made of one or more of plastic, metal, stone, wood, a natural material, a synthetic material, or composite material.
